(19) United States
(12) Patent Application Publication
(10) Pub. No.: US 2026/0029962 A1
(43) Pub. Date: Jan. 29, 2026

(54) OPTIMIZED MEDIA MANAGEMENT OPERATIONS BETWEEN MULTIPLE DATA STORAGE BANDS

(71) Applicant: Micron Technology, Inc., Boise, ID (US)

(72) Inventors: Byron D. Harris, Mead, CO (US); Paul Stonelake, Kihei, HI (US); Noorshaheen Mavungal Noorudheen, Longmont, CO (US)

(21) Appl. No.: 19/275,467

(22) Filed: Jul. 21, 2025

Related U.S. Application Data
(60) Provisional application No. 63/675,583, filed on Jul. 25, 2024.

(51) Int. Cl. G06F 3/06

(52) U.S. Cl. CPC G06F 3/0659; G06F 3/0611; G06F 3/0652; G06F 3/0679

(57) ABSTRACT

A system comprises a memory device comprising: a cache band, configured to store a first number of bits per memory cell; and a data band, configured to store a second number of bits per memory cell, wherein the second number of bits per memory cell is greater than the first number of bits per memory cell. The system further comprises a processing device, operatively coupled with the memory device, to perform operations. The processing device receives a request to write data to the memory device and writes the data to a memory segment of a plurality of memory segments in the cache band. The processing device determines whether characteristics of the data satisfy a threshold criterion associated with the cache band. Responsive to determining that the characteristics of the data satisfy the threshold criterion, the processing device selects a media management operation to be performed on the memory segment.

### RELATED

This application claims the benefit of U.S. Provisional Patent Application No. 63/675,583 filed Jul. 25, 2024, entitled “Optimized Media Management Operations Between Multiple Data Storage Bands” which is incorporated by reference herein.

### TECHNICAL FIELD

Embodiments of the disclosure relate generally to memory sub-systems, and more specifically, relate to optimized media management operations between multiple data storage bands in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of an example structure of the memory device in accordance with embodiments of the present disclosure.

FIG. 3 is a flow diagram of an example method to select a media management operation, in accordance with some embodiments of the present disclosure.

FIG. 4 is a flow diagram of an example media management operation, including cache band to data band folding when the corresponding criteria are satisfied, in accordance with some embodiments of the present disclosure.

FIG. 5 is a flow diagram of an example media management operation, including folding within the data band when the corresponding criteria are satisfied, in accordance with some embodiments of the present disclosure.

FIG. 6 is a flow diagram of an example media management operation, including folding within the cache band when the corresponding criteria are satisfied, in accordance with some embodiments of the present disclosure.

FIG. 7 is a block diagram of an example computer system in which embodiments of the present disclosure may operate.

### DETAILED DESCRIPTION

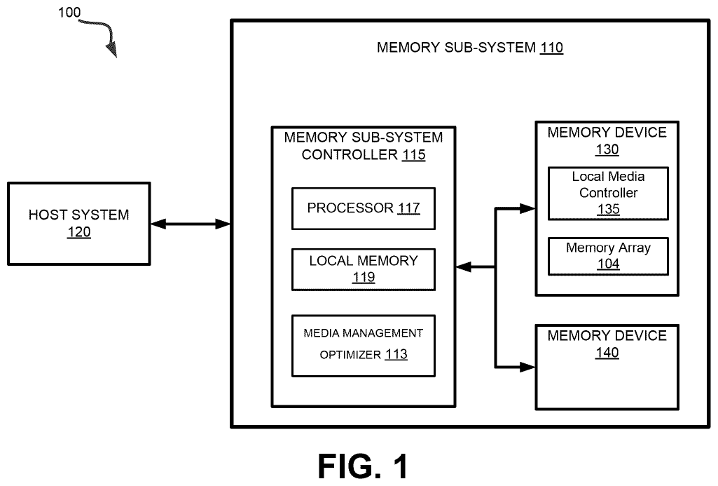

Aspects of the present disclosure are directed to optimized media management operations between multiple data storage bands. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

A memory device can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store two, three, and four bits per cell, respectively. Each cell stores data by maintaining a specific charge level within the cell, which corresponds to a voltage level. These voltage levels represent the binary data stored in the cells, with SLC having two levels (for 0 and 1), MLC four levels (for 00, 01, 10, 11), TLC eight levels (for 000 to 111), and QLC sixteen levels (for 0000 to 1111). Enhanced memory density offers numerous advantages; for example, Quad-Level Cell (QLC) technology, which stores four bits per cell, delivers increased storage capacity at a reduced cost per gigabyte. This makes it a compelling choice for scenarios where large storage capacity and affordability are prioritized over peak performance, such as in database applications.

The accuracy with which data can be read from or written to a cell depends on the clarity of the voltage levels stored thereon. Ideally, in memory storing multiple bits per cell, each voltage level would be distinct and easily distinguishable from the others, with some margin in between. Due to various factors, however, including manufacturing variances, wear, and temperature fluctuations, the charge stored in a cell—and thus its voltage level—can vary. This variance results in a distribution of threshold voltages (e.g., a “threshold voltage distribution”) for each voltage level. The spaces between these threshold voltage distributions (hereafter referred to as “valleys”) are used to differentiate between the threshold voltage distributions representing each possible data value. During a read operation, processing logic in the memory sub-system may determine the data stored in a memory cell by identifying which threshold voltage distribution (e.g., the range of voltages that have been predetermined by the memory controller to represent a data state) that the cell's measured threshold voltage (e.g., the actual voltage read during the operation) falls within. This operation can be executed by applying a read voltage, then comparing the cell's measured threshold voltage against this applied read voltage to determine its threshold voltage distribution.

As the number of bits per memory cell increases (e.g., from SLC to QLC), the number of threshold voltage distributions and corresponding voltage levels similarly increases. As a result, the valleys between these levels become narrower, increasing the precision required to distinguish between these distributions.

The narrower valleys can lead to issues in high density memory cells such as QLC. Memory segments (e.g., units of memory for management spanning wordlines, blocks, or multiple dies) that remain only partially written (“open”) are particularly susceptible to slow charge loss (SCL). SCL refers to the gradual shift in a memory cell's threshold voltage over time due to temperature changes and aging effects. This vulnerability arises because these “open” memory units may not enjoy the stability that fully written memory segments achieve. Coupled with narrow valleys between threshold voltage distributions, shifts resulting at least from SCL can lead to significant errors in data interpretation. Shifts can cause the threshold voltage of a cell to move closer to, or even cross into, the adjacent threshold voltage distribution, making it increasingly difficult for the processing logic to accurately determine the correct state of the cell and leading to potential read errors. Memory segments benefit from spending as little time as possible “open” and vulnerable, however especially with higher density memory, it may take long periods to complete writing data to a memory segment, exacerbating the issue.

In addition to the issues introduced by remaining open, the complexity of higher density memory requires precise control over the voltage levels within each cell, often necessitating the use of advanced programming techniques like multi-pass programming. In a two-pass programming method, a rough charge level is set initially and then refined in a second pass to achieve the target voltage level, ensuring accurate data storage. As a result of this complexity and structure, QLC and other high density memory techniques can suffer from slow write speeds in addition to lower endurance.

Aspects of the present disclosure address the above and other deficiencies by optimizing media management operations between multiple data storage bands in a memory sub-system. This is accomplished by employing triggers to select media management operations based on whether data characteristics meet threshold criteria. In one embodiment, the storage bands consist of a cache band, configured to store a first number of bits per memory cell, and a data band, configured to store a greater number of bits per memory cell than the cache band. In this embodiment, upon receiving a request to write data to the memory sub-system, the processing device writes the data to the cache band, which may span one or more memory devices depending on the embodiment. Specifically, the data is written to a segment of the memory in the cache band. In order to optimize the media management operations, the processing device obtains measurements of the data and selects the appropriate media management operation based on whether these measurements satisfy one or more threshold criteria associated with the cache band. In some embodiments, the media management operation entails moving data between the cache band and the data band, which may also span one or more memory devices in the memory sub-system depending on the embodiment. The media management operations available for selection can vary with regard to triggers (i.e., the threshold embodiments to be satisfied). Furthermore, the memory segment targeted by the media management operation can vary (i.e., different media management operations can have different “victim” memory segment selection processes). In some embodiments, based on the media management operation selected, an appropriate victim memory segment selection method is implemented.

In one embodiment, the system operates by writing data to the cache band and evaluating specific conditions to determine subsequent actions. The processing logic checks if the number of memory segments written to the cache band meets a defined written threshold criterion associated with the destination data band. Additionally, the processing logic assesses whether a total valid translation unit count (VTC) of these segments satisfies a validity threshold criterion linked to the data band. If both conditions are met, the system triggers a media management operation optimized for the characteristics associated with the data.

The present disclosure provides multiple benefits that address at least the issues described above. By optimizing the media management operations using triggers between multiple data storage bands, the processing logic can proactively mitigate conditions that can cause errors due to SCL. This is because the system evaluates memory segments against specific performance thresholds, such as the number of segments written and the validity threshold criteria of the segments. By using these thresholds, the system can decide when a memory segment should be written to the data band, reducing the time data remains in a less stable state and hence susceptible to SCL. For example, this approach can ensure memory segments written intermittently can adequately fill a target number of memory segments in the data band before actually moving to the data band, thus minimizing the danger of encountering the effects of SCL in the data band.

In addition, the variability of the triggers means that, depending on the set of media management operations organized for the processing logic to select from, there are circumstances where certain metrics, such as time, do not need to be tracked. This can further improve latency.

In addition, techniques using a lesser number of bits per memory cell may require a simpler programming process. This is a benefit with using the cache band to build the memory segments prior to the media management operation. For example, SLC, with just two voltage levels to manage and a larger margin, is reliable with only one programming pass. MLC and TLC, despite their increased complexity, can be written to reliably within a single programming pass. Because SLC, MLC, and TLC have fewer charge states to manage, they do not typically require the multi-pass programming techniques that QLC demands, allowing for simpler and faster programming processes while maintaining reasonable reliability and performance. By utilizing a cache band to quickly and reliably build memory segments in the foreground, while, in some embodiments, perform media management operations that may move the memory segment to the higher density data band in the background, the present disclosure allows for the memory device to retain the low cost and memory dense characteristics of storage mediums configured to store higher numbers of bits per memory cell (e.g., the data band configured for QLC) with the improved latency and endurance of storage mediums configured to store a lesser number of bits per memory cell (e.g., the cache band configured for SLC).

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a media management optimizer component 113 that can optimize media management operations between multiple data storage bands. In some embodiments, the memory sub-system controller 115 includes at least a portion of the media management optimizer component 113. In some embodiments, the media management optimizer component 113 is part of the host system 120, an application, or an operating system. In other embodiments, local media controller 135 includes at least a portion of media management optimizer component 113 and is configured to perform the functionality described herein.

The media management optimizer component 113 can optimize media management operations between multiple data storage bands, which may span one or more memory devices, such as memory device 130, in memory sub-system 110. This is accomplished by employing triggers to select operations for memory segments by employing triggers to select media management operations based on whether data characteristics meet threshold criteria. In one embodiment, the storage bands consist of a cache band, configured to store a first number of bits per memory cell (e.g., implemented using SLC memory storing one bit per cell), and a data band, configured to store a greater number of bits per memory cell than the cache band (e.g., implemented using QLC memory storing four bits per cell). In this embodiment, upon receiving a request to write data to the memory device, the media management optimizer component 113 writes the data to the cache band. Specifically, the data is written to a segment of the memory in the cache band. In order to optimize the media management operations, the media management optimizer component 113 obtains measurements of the data and selects the appropriate media management operation based on whether these measurements satisfy one or more threshold criteria associated with the cache band. In some embodiments, the media management operation entails moving data between the cache band and the data band. The media management operations available for selection can vary with regard to triggers (i.e., the threshold embodiments to be satisfied). Furthermore, the memory segment targeted by the media management operation can vary (i.e., different media management operations can have different “victim” memory segment selection processes). In some embodiments, based on the media management operation selected, an appropriate victim memory segment selection method is implemented. Further details with regards to the operations of the media management optimizer component 113 are described below.

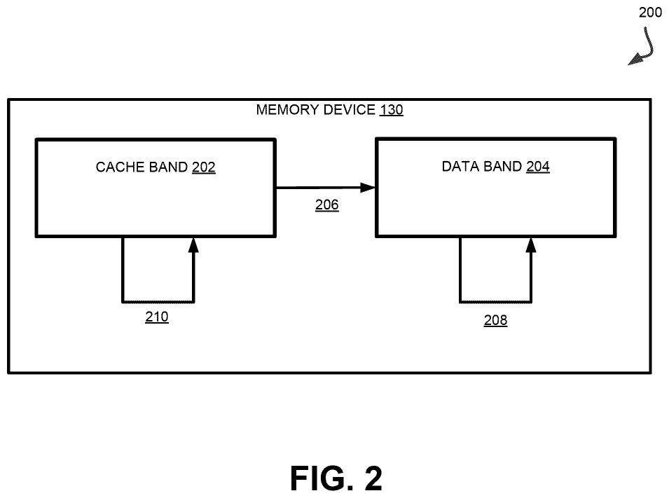

FIG. 2 is a block diagram 200 of an example structure of the memory device 130 in accordance with embodiments of the present disclosure. In some embodiments, the memory device 130 comprises a cache band 202, configured to store a first number of bits per memory cell; and a data band 204, configured to store a second number of bits per memory cell. In some embodiments, the second number of bits per memory cell (of the data band 204) is greater than the first number of bits per memory cell (of the cache band 202). For example, the cache band 202 can be configured to use an SLC memory storage method while the data band 204 is configured to store memory using a QLC storage method.

In some embodiments, the cache band 202 and the data band 204 are associated with a single memory device. In other embodiments, the cache band 202 and the data band 204 are located on separate memory devices. In some embodiments, the cache band 202 and the data band 204 each span across multiple memory devices. Some implementations implement a hybrid approach where the cache band 202 is on a dedicated device while the data band 204 spans multiple devices, and vice versa.

In addition, the block diagram 200 includes directions 206, 208, and 210 to illustrate example directions of data in different media management operations, in accordance with some embodiments of the present disclosure.

Possible media management operations include “folding.” Folding is a media management operation performed by the processing logic involving rearranging and consolidating memory segments to clear space occupied by “garbage” (invalid) data that is no longer in use. Folding merges smaller memory chunks into larger blocks to minimize fragmentation and wasted space in the memory device.

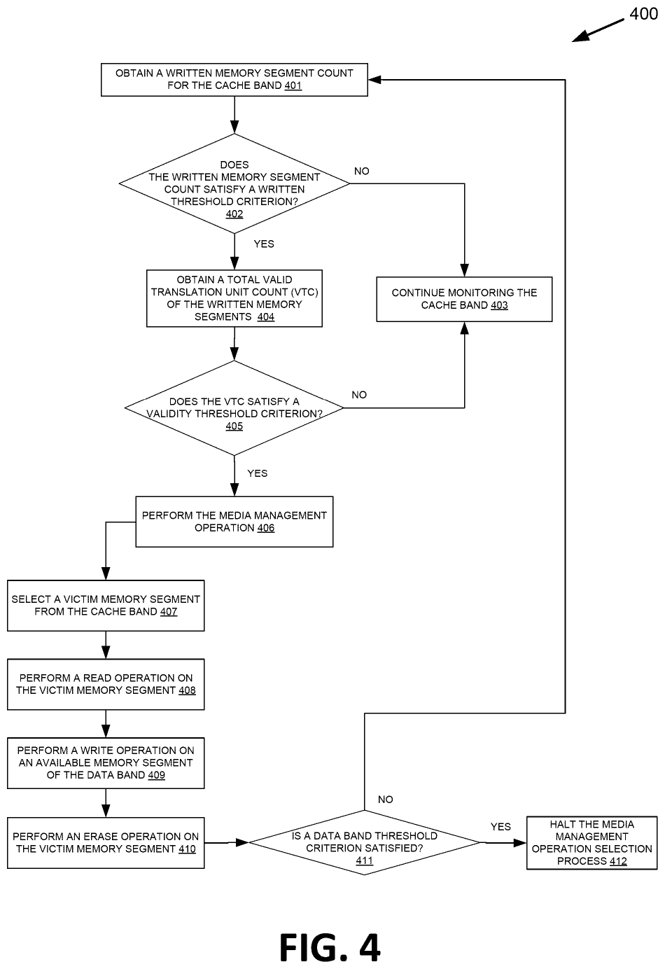

For example, data moving in direction 206 may be in accordance with a media management operation directed toward folding data from the cache band 202 to the data band 204 (i.e. “cache-to-data”). Data moving in direction 208 may be in accordance with a media management operation directed toward folding within the data band 204 (i.e. “data-to-data”). Data moving in direction 210 can be in accordance with a media management operation directed toward folding within the cache band 202 (i.e. “cache-to-cache”). Additional details are provided below with respect to FIGS. 4-6.

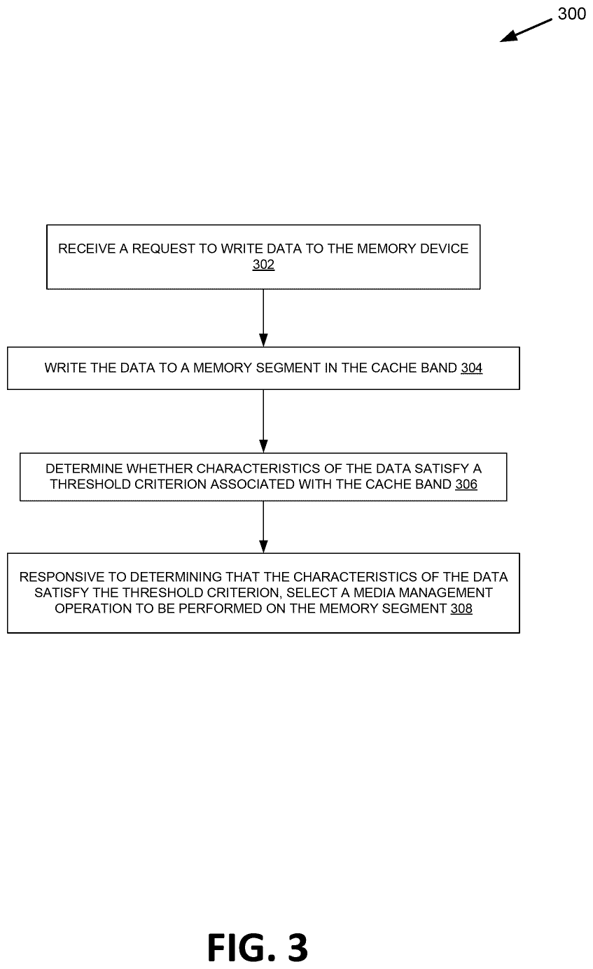

FIG. 3 is a flow diagram of an example method 300 to select a media management operation, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the media management optimizer component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 302, the processing logic (e.g., the media management optimizer component 113) receives a request to write data to a memory device, such as memory device 130 of memory sub-system 110. In some embodiments, this request is received from an external requestor, such as host system 120. In some embodiments, this request is received from an internal requestor, such as another component within memory sub-system 110. For example, memory sub-system controller 115 can request this write operation during a media management operation.

At operation 304, the processing logic writes the data to a memory segment of a plurality of memory segments in the cache band, such as cache band 202. In some embodiments, a memory segment can be described as a block stripe. A block stripe is a logical group of blocks across a plurality of dies, where there is one block from each plane of the die. Each block may only be a member of a single block stripe.

At operation 306, the processing logic determines whether characteristics of the data satisfy a threshold criterion associated with the cache band 202. Depending on the triggers employed and the corresponding threshold criterion that are satisfied, different media management operations can be employed. Additional details are provided below with respect to FIGS. 4-6.

At operation 308, responsive to determining that the characteristics of the data satisfy the threshold criterion, the processing logic selects a media management operation to be performed on the memory segment. In some embodiments, the media management operation is selected from a predetermined set of media management operations with associated corresponding threshold conditions. In some embodiments, multiple media management operations can be selected to be performed concurrently (i.e., at least partially overlapping in time), depending on the capabilities of the memory sub-system architecture. In embodiments, different media management operations have different destinations. The processing logic selects a media management operation based on the satisfaction of particular threshold criteria by the characteristics of the data. For example, in some embodiments the destination of the media management operation is the data band 204. In some embodiments the destination of the media management operation is the cache band 202.

FIG. 4 is one such example of a media management operation selection, including cache band to data band folding when the corresponding criteria are satisfied. FIG. 4 is a flow diagram of an example method 400 of satisfying threshold criteria that determine a media management operation selection, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the media management optimizer component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 401, the processing logic (e.g., media management optimizer component 113) obtains a written memory segment count for the cache band 202. In some embodiments, a memory segment can be a block stripe. In some embodiments, a written memory segment is counted when the entirety of the memory segment has been written to. For example, the processing logic can maintain a counter associated with the cache band 202, which can be incremented each time a memory segment is fully written. In some embodiments, a written memory segment count is obtained when a request to write data to the memory device has been received. In some embodiments, a written memory segment count is obtained at timed intervals. Other trigger events may be used to obtain the written memory segment count.

At operation 402, the processing logic determines whether the written memory segment count of the cache band 202 satisfies a written threshold criterion associated with the data band 204. In some embodiments, the written threshold criterion is based upon the number of memory segments of the cache band 202 necessary to fill a target amount of the data band 204. Thus, in some embodiments, the written threshold criterion is satisfied when the written memory segment count for the cache band 202 is greater than or equal to the target number of written memory segments. Conversely, a count of written memory segments falling below this target number indicates that the written threshold criterion is not satisfied.

Responsive to determining that the written memory segment count of the cache band fails to satisfy the written threshold criterion, at operation 403, the processing logic continues to monitor the cache band 202 for conditions that satisfy the written threshold criterion.

Responsive to determining that the written memory segment count of the cache band satisfies the written threshold criterion, at operation 404, the processing logic obtains a total valid translation unit count (total VTC) of the written memory segments in the cache band 202.

In some embodiments, a translation unit (TU) is the base granularity of data managed by the memory sub-system. A TU is associated with a set of memory cells. An invalid TU is associated with a set of memory cells comprising data that is no longer needed (e.g., overwritten, outdated, etc.). Conversely, a valid TU is associated with a set of memory cells comprising data that is of use. In some embodiments, obtaining a total VTC entails obtaining the number of valid TUs across the memory segments of a data storage band.

In some embodiments, the processing logic obtains the total VTC of the written memory segments of the cache band 202 responsive to determining that the written memory segment count of the cache band satisfies the written threshold criterion associated with the data band 204. In some embodiments, a total VTC count is obtained when a request to write data to the memory device has been received.

At operation 405, the processing logic determines whether the total VTC satisfies a validity threshold criterion, wherein the validity threshold criterion is associated with the data band 204. Over time, data within the written memory segments of the cache band 202 can be invalidated. For example, data can be invalidated when it is overwritten in a subsequent write operation. In some embodiments, the validity threshold criterion is satisfied when the written memory segments in the cache band 202 contain a measure of valid data (e.g., valid TUs) greater than or equal to a target measure associated with the data band 204. In some embodiments, this measure is represented by the number of valid translation units in a memory segment. In some embodiments, the target measure is based upon filling a target amount of the data band 204. Conversely, falling below this target measure indicates that the written threshold criterion is not satisfied.

Responsive to determining that the total VTC of the cache band fails to satisfy the validity threshold criterion, at operation 403, the processing logic continues to monitor the cache band 202 for conditions that satisfy the validity threshold criterion.

Responsive to determining that the characteristics of the data in the cache band satisfy the above threshold criteria, a corresponding media management operation is selected to be performed on a memory segment. In some embodiments, the media management operation is selected from a predetermined set of media management operations with associated corresponding threshold conditions. In FIG. 4, as the written threshold criterion and the validity threshold criterion are determined to be satisfied, at operation 406, the processing logic performs a media management operation where, in an embodiment, the data of a memory segment is “folded” from the cache band 202 to the data band 204 in direction 206 of FIG. 2.

In addition to garbage collection, folding data between storage areas with different data densities yields efficiency benefits. For example, data written to the cache band 202 using the first number of bits per cell is less information-dense than that written to the data band 204 using the second, greater number of bits per cell; rewriting a memory segment to the data band using the second number of bits per cell frees up space for new writes in the cache band and is more cost-effective for the memory device.

As part of a folding media management operation, at operation 407, the processing logic selects a “victim” memory segment. In some embodiments, the methodology behind the victim memory segment selection is determined by the media management operation that is selected and, in turn, the threshold criterion that is satisfied. In one embodiment, the victim memory segment is the oldest of the written memory segments in the cache band (e.g., the memory segment in the cache band that was written to first). Here, the victim memory segment is selected in accordance with a First-In-First-Out (FIFO) methodology. In NAND memory, where information is written to the memory sequentially, the oldest memory segment would be determined by the first memory segment written to the cache band 202. Due to the FIFO scheme the order of data movement is maintained, aligning with the sequence in which the data is written by the host.

At operation 408, the processing logic performs a read operation on the victim memory segment of the cache band 202, the victim memory segment comprising data stored using the first number of bits per memory cell.

At operation 409, the processing logic performs a write operation on an available memory segment of the data band 204 to write the data from the victim memory segment, wherein the available memory segment has not been written to and is configured to store the second number of bits per memory cell.

At operation 410, the processing logic performs an erase operation on the victim memory segment of the cache band 202.

In some embodiments, at operation 411, the processing logic determines whether a data band threshold criterion is satisfied. Responsive to determining the data band threshold criterion is satisfied, at operation 412, the processing logic halts the media management operation selection process. Responsive to determining the data band threshold criterion is not satisfied, the processing logic resumes the media management operation selection process at operation 401 to determine whether the requirements for performing the media management operation at operation 406 are met.

In some embodiments, the data band threshold criterion is satisfied when the data band 204 is full and can no longer be written to. In some embodiments, the data band threshold criterion is satisfied when a threshold number of a media management operation is performed (e.g., a threshold number of victim memory segments are used in a media management operation to the data band 204. In this embodiment, responsive to determining the data band threshold criterion is satisfied, the processing logic writes padding data to the available memory segments in the data band 204. Here, padding refers to the practice of adding extra, typically non-functional, data (e.g., “padding data”) to the data band to achieve a desired capacity.

In some embodiments, the processing logic monitors the duration of time for the completion of the media management operation. The processing logic monitors a duration of time for performing the write operation 409 on the available memory segment of the data band. Responsive to determining that the duration of time satisfies a duration threshold criterion, the processing logic writes dummy data to the available memory segment, wherein the dummy data is invalid data. Satisfying the duration threshold condition would entail the duration of time exceeding a predetermined duration. Failing to satisfy the duration threshold condition entails a duration of time less than or equal to the predetermined duration. This can ensure underrun conditions where, during the folding process, data in the victim memory segment is invalidated, do not prevent the completion of the media management operation and allow a memory segment to remain open and especially vulnerable to SCL.

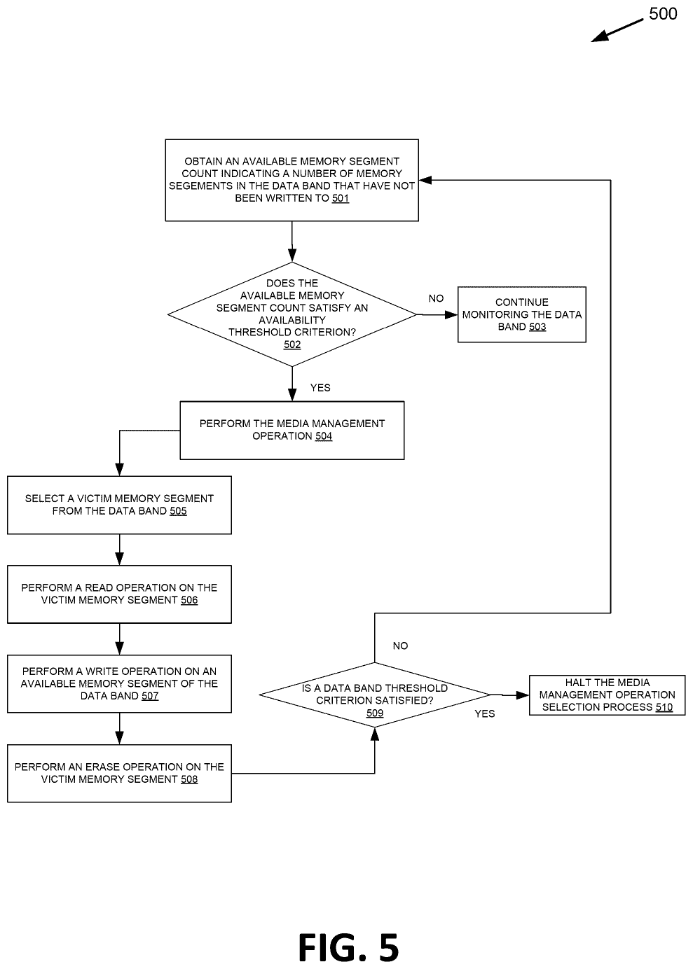

FIG. 5 is another example of a media management operation selection, including folding within the data band 204 when the corresponding criteria are satisfied. FIG. 5 is a flow diagram of an example method 500 of satisfying threshold criteria that determine a media management operation selection, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the media management optimizer component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 501, the processing logic obtains an available memory segment count for the data band 204. In some embodiments, a memory segment can be a block stripe. In some embodiments, an available memory segment is counted when it is available to be written to. For example, the processing logic can maintain a counter associated with the data band 204, which can be decremented each time a memory segment is fully written, and thus is no longer available. In some embodiments, an available memory segment count is obtained when a request to write data to the memory device has been received. In some embodiments, an available memory segment count is obtained at timed intervals. Other trigger events may be used to obtain the available memory segment count.

At operation 502, the processing logic determines whether the available memory segment count of the data band satisfies an availability threshold criterion associated with the data band 204. In some embodiments, the availability threshold criterion is based upon the total number of memory segments in the data band 204; the total number of memory segments can indicate the total capacity of the data band. In some embodiments, satisfying the availability threshold criterion means the number of available memory segments in the data band exceeds a predefined maximum threshold, suggesting that the data band 204 is nearing full capacity and might soon be unable to accommodate additional write operations. Conversely, a count of available memory segments falling below this maximum indicates that the availability threshold criterion is not satisfied.

Responsive to determining that the available memory segment count of the data band fails to satisfy the availability threshold criterion, at operation 503, the processing logic continues to monitor the data band 204 for conditions that satisfy the written threshold criterion.

Responsive to determining that the characteristics of the data in the data band satisfy the availability threshold criterion, a media management operation is selected to be performed on a memory segment. In FIG. 5, as the availability threshold criterion is determined to be satisfied, at operation 504, the processing logic performs a media management operation where, in an embodiment, the data of a memory segment is “folded” from the data band 204 back into the data band 204 in direction 208 of FIG. 2.

Here, the primary benefit of a folding operation comes from the garbage collection aspect. In rewriting the valid data from written memory segments into available memory segments, without rewriting “garbage” (invalid) data that is no longer in use, the media management operation frees up space for new writes in the data band 204.

As part of a folding media management operation, at operation 505, the processing logic selects a “victim” memory segment from the data band. In some embodiments, the methodology behind the victim memory segment selection is determined by the media management operation that is selected and, in turn, the threshold criterion satisfied. In one embodiment, the victim memory segment is the memory segment with the lowest individual valid translation unit count (individual VTC). In some embodiments, the individual VTC of each memory segment can be obtained by the processing logic in an iterative one-by-one manner. In some embodiments, the individual VTCs can be monitored by the processing logic using a table or other medium.

At operation 506, the processing logic performs a read operation on the victim memory segment of the data band, the victim memory segment comprising data stored using the second number of bits per memory cell.

At operation 507, the processing logic performs a write operation on an available memory segment of the data band 204 to write the data from the victim memory segment, wherein the available memory segment is available to be written to.

At operation 508, the processing logic performs an erase operation on the victim memory segment of the data band 204.

In some embodiments, at operation 509, the processing logic determines whether a data band threshold criterion is satisfied. Responsive to determining the data band threshold criterion is satisfied, at operation 510, the processing logic halts the media management operation selection process. Responsive to determining the data band threshold criterion is not satisfied, the processing logic resumes the media management operation selection process at operation 501 to determine whether the requirements for performing the media management operation at operation 504 are met.

In some embodiments, the data band threshold criterion is satisfied when the data band 204 is full and can no longer be written to. In some embodiments, the data band threshold criterion is satisfied when a threshold number of a media management operation is performed (e.g., a threshold number of victim memory segments are used in a media management operation to the data band 204. In this embodiment, responsive to determining the data band threshold criterion is satisfied, the processing logic writes padding data to the available memory segments in the data band 204. Here, padding refers to the practice of adding extra, typically non-functional, data (e.g., “padding data”) to the data band to achieve a desired capacity.

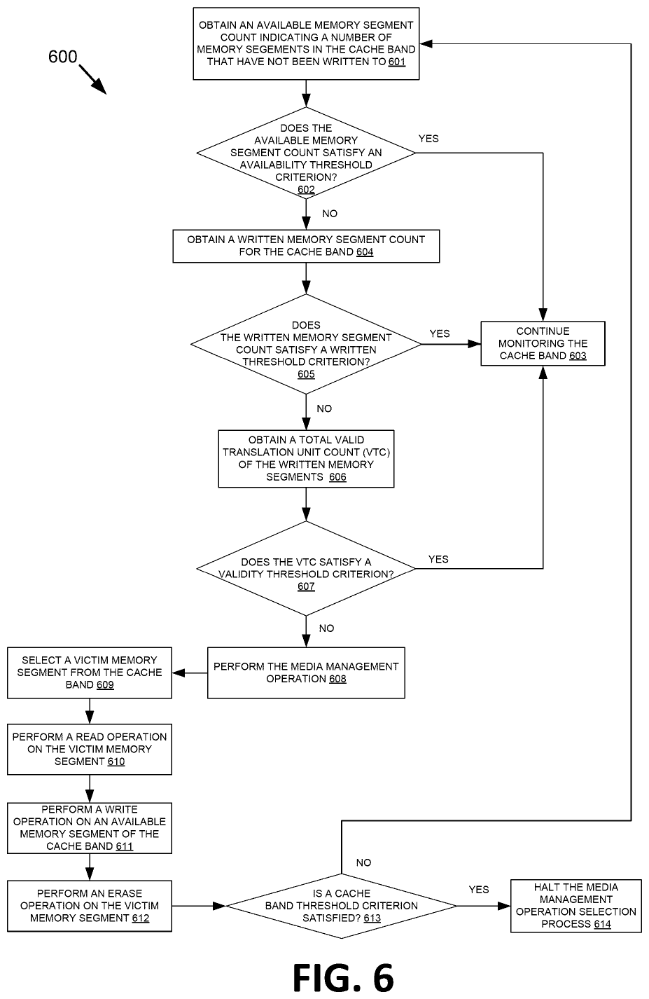

FIG. 6 is another example of a media management operation selection, including folding within the cache band 202 when the corresponding criteria are satisfied. FIG. 6 is a flow diagram of an example method 600 of satisfying threshold criteria that determine a media management operation selection, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the media management optimizer component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 601, the processing logic obtains an available memory segment count for the cache band 202. In some embodiments, a memory segment can be a block stripe. In some embodiments, an available memory segment is counted when it is available to be written to. In some embodiments, an available memory segment count is obtained when a request to write data to the memory device has been received. In some embodiments, an available memory segment count is obtained at timed intervals. Other trigger events may be used to obtain the available memory segment count.

At operation 602, the processing logic determines whether an available memory segment count of the cache band satisfies an availability threshold criterion associated with the cache band 202. In some embodiments, the availability threshold criterion is based upon the total number of memory segments in the cache band 202; the total number of memory segments can indicate the total capacity of the cache band. In some embodiments, satisfying the availability threshold criterion means the number of available memory segments in the cache band exceeds a predefined maximum threshold, suggesting that the cache band 202 is nearing capacity and might soon be unable to accommodate additional write operations. Conversely, a count of available memory segments falling below this maximum indicates that the availability threshold criterion for the cache band is not satisfied. In some embodiments, satisfying the availability threshold criterion means the number of available memory segments in the cache band is equal to the capacity of the cache band 202.

Responsive to determining that the available memory segment count of the cache band satisfies the availability threshold criterion, at operation 603, the processing logic continues to monitor the cache band 202 for conditions that fail to satisfy the written threshold criterion.

Responsive to determining that the characteristics of the data in the cache band fails to satisfy the availability threshold criterion (i.e., there is not enough available memory segments in the cache band 202), at operation 605, the processing logic obtains a written memory segment count for the cache band. In some embodiments, a written memory segment is counted when the entirety of the memory segment has been written to. In some embodiments, a written memory segment count is obtained when a request to write data to the memory device has been received. In some embodiments, a written memory segment count is obtained at timed intervals. Other trigger events may be used to obtain the written memory segment count.

At operation 606, the processing logic determines whether the written memory segment count of the cache band satisfies a written threshold criterion associated with the data band 204. In some embodiments, the written threshold criterion is based upon the number of memory segments of the cache band 202 necessary to fill a target amount of the data band 204. Satisfying the written threshold criterion means the cache band has a number of written memory segments greater than or equal to the target number of written memory segments. Conversely, a count of written memory segments falling below this target number indicates that the written threshold criterion is not satisfied.

Responsive to determining that the written memory segment count of the cache band satisfies the availability threshold criterion, at operation 603, the processing logic continues to monitor the cache band 202 for conditions that fail to satisfy the written threshold criterion.

At operation 606, the processing logic obtains a total valid translation unit count (total VTC) of the written memory segments in the cache band 202. In some embodiments, the processing logic obtains the total VTC responsive to determining that the written memory segment count of the cache band fails to satisfy the written threshold criterion associated with the data band 204. In some embodiments, a total VTC is obtained when a request to write data to the memory device has been received.

At operation 607, the processing logic determines whether the total VTC satisfies a validity threshold criterion, wherein the validity threshold criterion is associated with the data band. As memory sits in the cache band 202, data within the written memory segments can be invalidated. For example, data can be invalidated when it is overwritten in a subsequent write operation. In some embodiments, satisfying the validity threshold criterion means that the written memory segments in the cache band 202 contain a measure of valid data greater than or equal to a target measure associated with the data band 204. In some embodiments, the target measure is based upon filling a target amount of the data band 204. Conversely, falling below this target measure of valid data in the written memory segments of the cache band 202 means failing to satisfy the validity threshold criterion.

Responsive to determining that the total VTC of the cache band satisfies the validity threshold criterion, at operation 603, the processing logic continues to monitor the cache band 202 for conditions that fail to satisfy the validity threshold criterion.

Responsive to determining that the characteristics of the data in the cache band fail to satisfy the above threshold criteria, a corresponding media management operation is selected to be performed on a memory segment. In FIG. 6, as the availability threshold criterion, written threshold criterion, and validity threshold criterion are determined to be satisfied for the cache band, at operation 608, the processing logic performs a media management operation where, in an embodiment, the data of a memory segment is “folded” from the cache band 202 into an available memory segment of the cache band 202 in direction 210 of FIG. 2.

Here, the primary benefit of a folding operation comes from the garbage collection aspect. In rewriting the valid data from written memory segments into available memory segments, without rewriting “garbage’ (invalid) data that is no longer in use, the media management operation frees up space for new writes in the cache band 202.

As part of a folding media management operation, at operation 609, the processing logic selects a “victim” memory segment from the cache band. In some embodiments, the methodology behind the victim memory segment selection is determined by the media management operation that is selected and, in turn, the threshold criterion satisfied. In one embodiment, the victim memory segment is the memory segment with the lowest individual valid translation unit count (individual VTC). In some embodiments, the individual VTC of each memory segment can be obtained by the processing logic in an iterative one-by-one manner. In some embodiments, the individual VTCs can be monitored by the processing logic using a table or other medium.

At operation 610, the processing logic performs a read operation on the victim memory segment of the cache band, the victim memory segment comprising data stored using the first number of bits per memory cell.

At operation 611, the processing logic performs a write operation on an available memory segment of the cache band 202 to write the data from the victim memory segment, wherein the available memory segment is available to be written to.

At operation 612, the processing logic performs an erase operation on the victim memory segment of the cache band 202.

In some embodiments, at operation 613, the processing logic determines whether a cache band threshold criterion is satisfied. Responsive to determining the cache band threshold criterion is satisfied, at operation 614, the processing logic halts the media management operation selection process. Responsive to determining the cache band threshold criterion is not satisfied, the processing logic resumes the media management operation selection process at operation 601 to determine whether the requirements for performing the media management operation at operation 608 are met.

In some embodiments, the cache band threshold criterion is satisfied when the cache band 202 is full and can no longer be written to. In some embodiments, the cache band threshold criterion is satisfied when a threshold number of a media management operation is performed (e.g., a threshold number of victim memory segments are used in a media management operation to the cache band 202. In this embodiment, responsive to determining the cache band threshold criterion is satisfied, the processing logic writes padding data to the available memory segments in the cache band 202. Here, padding refers to the practice of adding extra, typically non-functional, data (e.g., “padding data”) to the cache band to achieve a desired capacity.

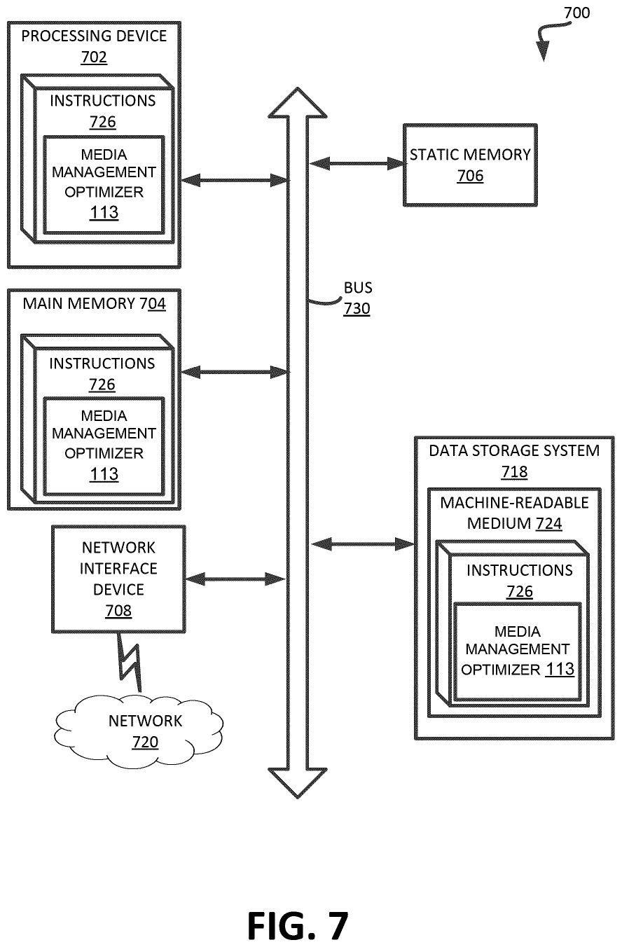

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media management optimizer component 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a media management optimizer component (e.g., the media management optimizer component 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device, comprising:
a cache band, configured to store a first number of bits per memory cell; and
a data band, configured to store a second number of bits per memory cell, wherein the second number of bits per memory cell is greater than the first number of bits per memory cell; and
a processing device, operatively coupled with the memory device, to perform operations comprising:
receiving a request to write data to the memory device;
writing the data to a memory segment of a plurality of memory segments in the cache band; and
determining whether characteristics of the data satisfy a threshold criterion associated with the cache band; and
responsive to determining that the characteristics of the data satisfy the threshold criterion, selecting a media management operation to be performed on the memory segment.

2. The system of claim 1, wherein determining whether the characteristics of the data satisfy the threshold criterion comprises:
obtaining a written memory segment count of written memory segments for the cache band;
determining that the written memory segment count satisfies a written threshold criterion;
obtaining a total valid translation unit count (VTC) of the written memory segments; and
determining that the total VTC satisfies a validity threshold criterion, wherein the validity threshold criterion is associated with the data band.

3. The system of claim 2, further comprising:
performing the media management operation, wherein performing the media management operation comprises:
selecting a victim memory segment, wherein the victim memory segment is an oldest of the written memory segments in the cache band;
performing a read operation on the victim memory segment;
performing a write operation on an available memory segment of the data band to write the data from the victim memory segment, wherein the available memory segment has not been written to and is configured to store the second number of bits per memory cell; and
performing an erase operation on the victim memory segment of the cache band.

4. The system of claim 3, further comprising:
monitoring a duration of time for performing the write operation on the available memory segment of the data band; and
responsive to determining that the duration of time satisfies a duration threshold criterion, writing dummy data to the available memory segment, wherein the dummy data is invalid data.

5. The system of claim 1, further comprising:
obtaining an available memory segment count for the data band, the available memory segment count indicating a number of memory segments that are available to be written to in the data band;
responsive to determining that the available memory segment count fails to satisfy an availability threshold criterion;
selecting a victim memory segment, wherein the victim memory segment has a lowest individual VTC of the plurality of memory segments in the data band;
performing a read operation on the victim memory segment;
performing a write operation on an available memory segment of the data band to write the data from the victim memory segment, wherein the available memory segment has not been written to; and
performing an erase operation on the victim memory segment of the data band.

6. The system of claim 1, wherein determining whether the characteristics of the data satisfy the threshold criterion comprises:
obtaining an available memory segment count for the cache band, the available memory segment count indicating a number of memory segments that have not been written to in the data band;
responsive to determining that the available memory segment count fails to satisfy an availability threshold criterion;
obtaining a written memory segment count for the cache band;
determining that the written memory segment count fails to satisfy a written threshold criterion;
obtaining a valid translation unit count (VTC) of the memory segments that have been written to; and
determining that the VTC fails to satisfy a validity threshold criterion, wherein the validity threshold criterion is associated with a data band.

7. The system of claim 6, further comprising:
performing the media management operation, wherein performing the media management operation comprises:
selecting a victim memory segment, wherein the victim memory segment has a lowest individual VTC of the plurality of memory segments in the cache band;
performing a read operation on the victim memory segment;
performing a write operation on an available memory segment of the cache band to write the data from the victim memory segment, wherein the available memory segment has not been written to; and
performing an erase operation on the victim memory segment.

8. A method comprising:
receiving a request to write data to a memory device, the memory device comprising:
a cache band, configured to store a first number of bits per memory cell; and
a data band, configured to store a second number of bits per memory cell, wherein the second number of bits per memory cell is greater than the first number of bits per memory cell;
writing the data to a memory segment of a plurality of memory segments in the cache band;
determining whether characteristics of the data satisfy a threshold criterion associated with the cache band; and
responsive to determining that the characteristics of the data satisfy the threshold criterion, selecting a media management operation to be performed on the memory segment.

9. The method of claim 8, wherein determining whether the characteristics of the data satisfy the threshold criterion comprises:
obtaining a written memory segment count of written memory segments for the cache band;
determining that the written memory segment count satisfies a written threshold criterion;
obtaining a total valid translation unit count (VTC) of the written memory segments; and
determining that the total VTC satisfies a validity threshold criterion, wherein the validity threshold criterion is associated with the data band.

10. The method of claim 9, further comprising:
performing the media management operation, wherein performing the media management operation comprises:
selecting a victim memory segment, wherein the victim memory segment is an oldest of the written memory segments in the cache band;
performing a read operation on the victim memory segment;
performing a write operation on an available memory segment of the data band to write the data from the victim memory segment, wherein the available memory segment has not been written to and is configured to store the second number of bits per memory cell; and
performing an erase operation on the victim memory segment of the cache band.

11. The method of claim 10, further comprising:
monitoring a duration of time for performing the write operation on the available memory segment of the data band; and
responsive to determining that the duration of time satisfies a duration threshold criterion, writing dummy data to the available memory segment, wherein the dummy data is invalid data.

12. The method of claim 8, further comprising:
obtaining an available memory segment count for the data band, the available memory segment count indicating a number of memory segments that have not been written to in the data band;
responsive to determining that the available memory segment count fails to satisfy an availability threshold criterion;
selecting a victim memory segment, wherein the victim memory segment has a lowest individual VTC of the plurality of memory segments in the data band;
performing a read operation on the victim memory segment;
performing a write operation on an available memory segment of the data band to write the data from the victim memory segment, wherein the available memory segment has not been written to; and
performing an erase operation on the victim memory segment of the data band.

13. The method of claim 8, wherein determining whether the characteristics of the data satisfy the threshold criterion comprises:
obtaining an available memory segment count for the cache band, the available memory segment count indicating a number of memory segments that have not been written to in the data band;
determining that the available memory segment count fails to satisfy an availability threshold criterion;
obtaining a written memory segment count for the cache band;
determining that the written memory segment count fails to satisfy a written threshold criterion;
obtaining a valid translation unit count (VTC) of the memory segments that have been written to; and
determining that the VTC fails to satisfy a validity threshold criterion, wherein the validity threshold criterion is associated with a data band.

14. The method of claim 13, further comprising:
performing the media management operation, wherein performing the media management operation comprises:
selecting a victim memory segment, wherein the victim memory segment has a lowest individual VTC of the plurality of memory segments in the cache band;
performing a read operation on the victim memory segment;
performing a write operation on an available memory segment of the cache band to write the data from the victim memory segment, wherein the available memory segment has not been written to; and
performing an erase operation on the victim memory segment.

15. A non-transitory computer-readable storage medium comprising instructions that, when executed by a processing device, cause the processing device to perform operations comprising:
receiving a request to write data to a memory device, the memory device comprising:
a cache band, configured to store a first number of bits per memory cell; and
a data band, configured to store a second number of bits per memory cell, wherein the second number of bits per memory cell is greater than the first number of bits per memory cell;
writing the data to a memory segment of a plurality of memory segments in the cache band;
determining whether characteristics of the data satisfy a threshold criterion associated with the cache band; and
responsive to determining that the characteristics of the data satisfy the threshold criterion, selecting a media management operation to be performed on the memory segment.

16. The non-transitory computer-readable storage medium of claim 15, wherein determining whether the characteristics of the data satisfy the threshold criterion comprises:
obtaining a written memory segment count of written memory segments for the cache band;
determining that the written memory segment count satisfies a written threshold criterion;
obtaining a total valid translation unit count (VTC) of the written memory segments; and
determining that the total VTC satisfies a validity threshold criterion, wherein the validity threshold criterion is associated with the data band.

17. The non-transitory computer-readable storage medium of claim 16, further comprising:
performing the media management operation, wherein performing the media management operation comprises:
selecting a victim memory segment, wherein the victim memory segment is an oldest of the written memory segments in the cache band;
performing a read operation on the victim memory segment;
performing a write operation on an available memory segment of the data band to write the data from the victim memory segment, wherein the available memory segment has not been written to and is configured to store the second number of bits per memory cell; and
performing an erase operation on the victim memory segment of the cache band.

18. The non-transitory computer-readable storage medium of claim 15, further comprising:
obtaining an available memory segment count for the data band, the available memory segment count indicating a number of memory segments that have not been written to in the data band;
responsive to determining that the available memory segment count fails to satisfy an availability threshold criterion;
selecting a victim memory segment, wherein the victim memory segment has a lowest individual VTC of the plurality of memory segments in the data band;
performing a read operation on the victim memory segment;
performing a write operation on an available memory segment of the data band to write the data from the victim memory segment, wherein the available memory segment has not been written to; and
performing an erase operation on the victim memory segment of the data band.

19. The non-transitory computer-readable storage medium of claim 15, wherein determining whether the characteristics of the data satisfy the threshold criterion comprises:
obtaining an available memory segment count for the cache band, the available memory segment count indicating a number of memory segments that have not been written to in the data band;
determining that the available memory segment count fails to satisfy an availability threshold criterion;
obtaining a written memory segment count for the cache band;
determining that the written memory segment count fails to satisfy a written threshold criterion;
obtaining a valid translation unit count (VTC) of the memory segments that have been written to; and
determining that the VTC fails to satisfy a validity threshold criterion, wherein the validity threshold criterion is associated with a data band.

20. The non-transitory computer-readable storage medium of claim 19, further comprising:
performing the media management operation, wherein performing the media management operation comprises:
selecting a victim memory segment, wherein the victim memory segment has a lowest individual VTC of the plurality of memory segments in the cache band;
performing a read operation on the victim memory segment;
performing a write operation on an available memory segment of the cache band to write the data from the victim memory segment, wherein the available memory segment has not been written to; and
performing an erase operation on the victim memory segment.
